(19) United States
(12) Patent Application Publication
(10) Pub. No.: US 2013/0314869 A1
(43) Pub. Date: Nov. 28, 2013

(54) MINICOMPUTER HAVING MALE CONNECTOR

(71) Applicant: Nai-Chien CHANG, New Taipei City (TW)

(72) Inventor: Nai-Chien CHANG, New Taipei City (TW)

(21) Appl. No.: 13/831,012

(22) Filed: Mar. 14, 2013

(30) Foreign Application Priority Data
May 24, 2012 (TW) 101209859

(51) Int. Cl. G06F 1/16

(52) U.S. Cl. CPC G06F 1/16
USPC 361/679.33; 361/679.31

(57) ABSTRACT

A minicomputer includes a small size mainboard. A processing unit, a memory, a storage unit, at least a female connector, and at least a male connector are arranged on the mainboard. The storage unit stores an operating system of the minicomputer. The processing unit and the memory are configured to process the operating system. The female connectors are electrically connected to peripherals of the minicomputer. The minicomputer is directly plugged into a female connector of an external monitor through the male connector. The minicomputer is configured to transmit video and audio signals to the external monitor for displaying.

### BACKGROUND OF THE INVENTION

1. Field of the Invention

The present invention relates to a computer, and especially relates to a minicomputer which is configured to transmit video and audio signals to an external monitor for displaying.

2. Description of the Related Art

In recent years, computers are very popular, so that every household has computers. A conventional computer includes a mainboard, a central process unit (CPU), a random access memory (RAM), a display card, a sound card, a cooling fan, a plurality of connectors, a casing, and so on. Therefore, the conventional computer is bulky, and is difficult to move or carry.

However, the semiconductor technology is progressing every day, so that the electronic components are smaller and the efficiency is higher. For example, the CPU and RAM mentioned above are smaller, the efficiency is higher, and the heat dissipation is better. Moreover, the display card and the sound card are built on the mainboard. Therefore, a minicomputer is provided in the market.

FIG. 1 shows a schematic diagram of a related art minicomputer. A minicomputer 1 is much smaller than the conventional computer mentioned above. The connection between the minicomputer 1 and the peripheral is similar to the connection between the conventional computer and the peripheral. For example, the minicomputer 1 includes a plurality of connectors 11. Therefore, the minicomputer 1 is configured to transmit video signals to an external monitor 21 for displaying. Moreover, a user may control the minicomputer 1 through a keyboard 22 and a mouse 23.

Moreover, the minicomputer 1 is connected to a power cord 12 through the connector 11 (for example, a DC-jack) for receiving wall socket power (electric power).

Although the minicomputer 1 is small and portable, a lot of cords are still required for connecting to the external monitor 21, the keyboard 22, the mouse 23, and so on. It is inconvenient for the user to carry the cords when using the minicomputer 1.

### SUMMARY OF THE INVENTION

In order to solve the above-mentioned problems, an object of the present invention is to provide a minicomputer having a male connector. The minicomputer is directly plugged into an external monitor. The minicomputer is configured to transmit video and audio signals to the external monitor for displaying.

In order to achieve the object of the present invention mentioned above, the minicomputer includes a small size mainboard, a processing unit, a memory, a storage unit, at least a female connector, and at least a male connector. The processing unit, the memory, the storage unit, the female connector, and the male connector are arranged on the mainboard. The storage unit stores an operating system of the minicomputer. The processing unit and the memory are configured to process the operating system. The female connectors are electrically connected to peripherals of the minicomputer. The male connector is directly plugged into a female connector of the external monitor. The minicomputer is configured to transmit video and audio signals to the external monitor for displaying.

The efficiency of the present invention is that the minicomputer is small because the minicomputer does not have the monitor and the input units. The minicomputer includes the male connector for directly plugging into the external monitor. The minicomputer is configured to transmit video and audio signals to the external monitor for displaying. Therefore, the cord connecting the minicomputer and the external monitor is not required.

### BRIEF DESCRIPTION OF DRAWING

FIG. 1 shows a schematic diagram of a related art minicomputer.

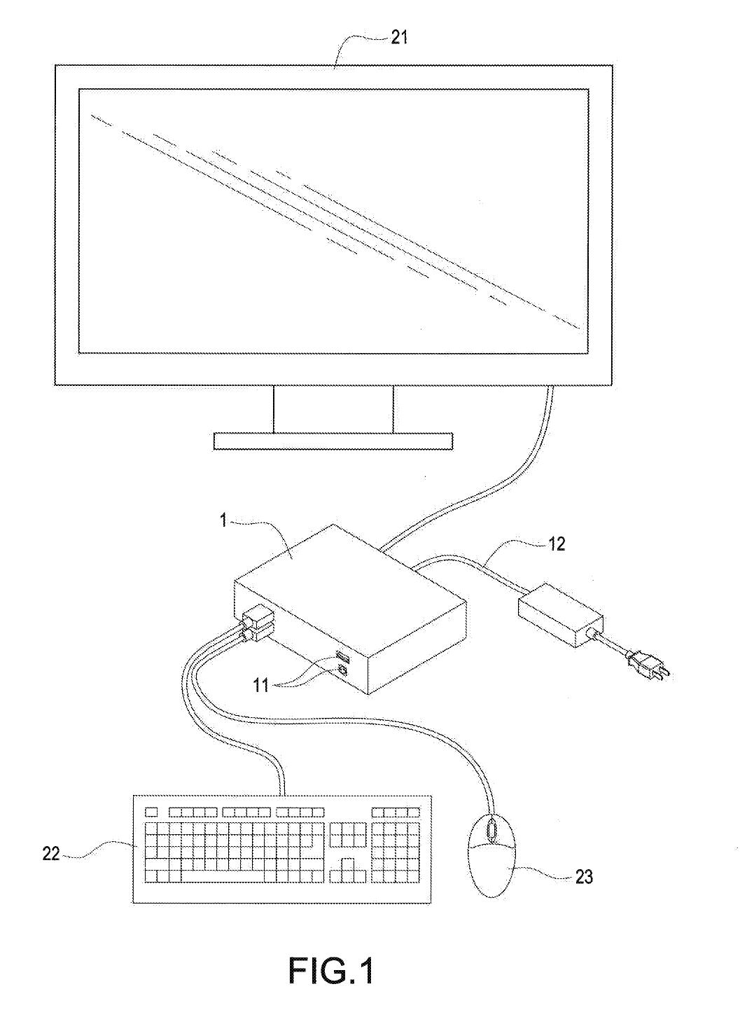

FIG. 2 shows an exploded view of the minicomputer of the present invention.

FIG. 3 shows a perspective view of the assembled bled minicomputer of the present invention.

FIG. 4 shows a connection diagram of the minicomputer of the present invention.

FIG. 5 shows a diagram showing how the minicomputer of the present invention is used.

FIG. 6 shows another schematic diagram showing the application of the minicomputer of the present invention.

### DETAILED DESCRIPTION OF THE INVENTION

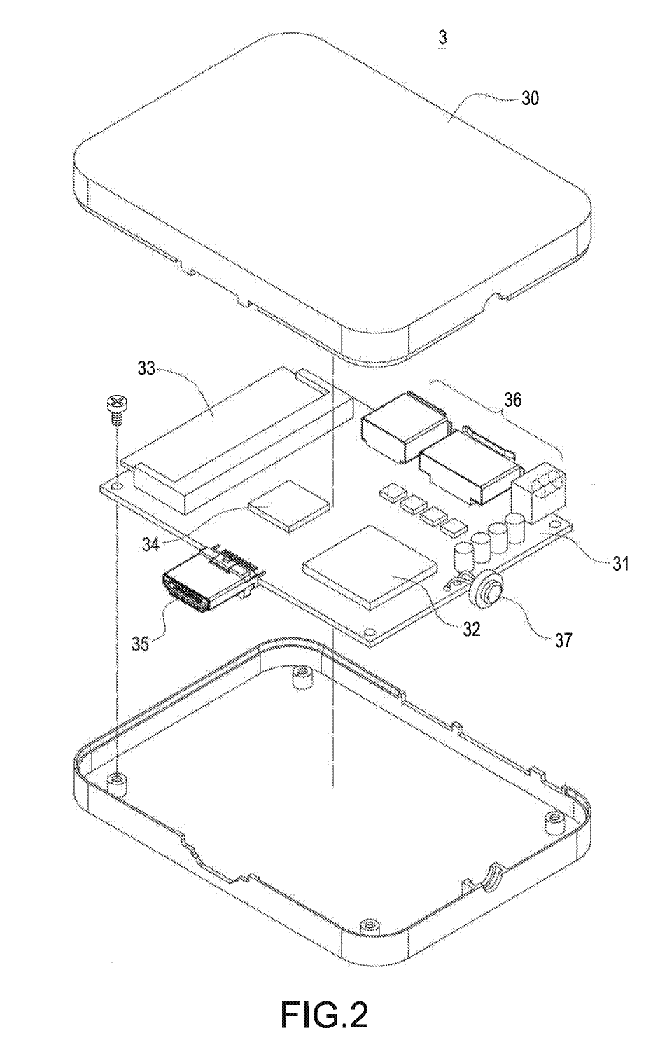

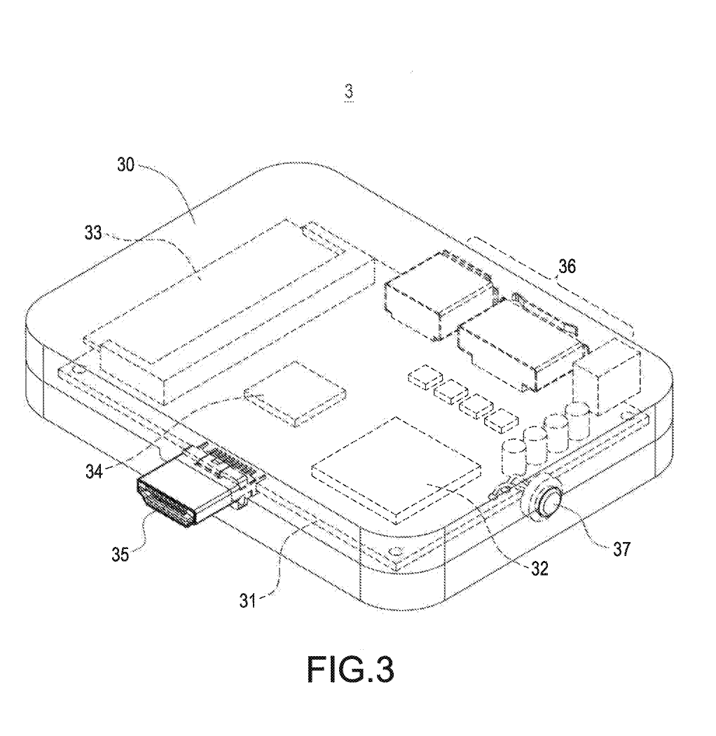

FIG. 2 shows an exploded view of the minicomputer of the present invention. FIG. 3 shows a perspective view of the assembled minicomputer of the present invention. A minicomputer 3 includes a mainboard 31, a processing unit 32, a memory 33, a storage unit 34, a male connector 35, and at least a connector 36. The size of the mainboard 31 is smaller than the size of the conventional mainboard used in a personal computer or a notebook. The processing unit 32, the memory 33, the storage unit 34, the male connector 35, and the connector 36 are electrically connected to and arranged on the mainboard 31.

The processing unit 32 is a central process unit (CPU) or a micro control unit (MCU) for processing all control signals of the minicomputer 3. The memory 33 is, for example but not limited to, a random access memory (RAM). The storage unit 34 is, for example but not limited to, a flash memory or a solid state disk (SSD) which includes a plurality of the flash memories. The storage unit 34 stores at least an operating system (OS) of the minicomputer 3, for examples, the Android developed by the Google incorporation, the Windows developed by the Microsoft incorporation, or the iOS developed by the Apple incorporation, and the related application programs. The processing unit 32 and the memory 33 are configured to process the operating system and the related application programs. Therefore, the minicomputer 3 is a small-sized computer without a monitor and input units after the operating system is processing.

As mentioned above, the minicomputer 3 does not have any monitor. Therefore, the volume of the minicomputer 3 is minimized. The video signals and audio signals generated by the operating system are outputted through the male connector 35 when the user uses the minicomputer 3.

Moreover, the minicomputer 3 does not have any input units. Therefore, the connector 36 is used to electrically connect to the peripherals of the minicomputer 3. In FIGS. 2 and 3, the male connector 35 is a high definition multimedia interface (HDMI) male connector. The connector 36 is a universal serial bus (USB) connector, an external serial advanced technology attachment (e-SATA) connector, or a direct current (DC) jack. Moreover, the male connector 35 and the connector 36 are, for examples but not limited to, the Thunderbolt connectors, the DisplayPort connectors, the RJ-45 connectors, or the S/PDIF connectors.

Moreover, the minicomputer 3 further includes a power switch 37 electrically connected to the mainboard 31. The minicomputer 3 is connected to electric power through the connector 36 or the male connector 35. The user may press the power switch 37 to turn on the minicomputer 3. The operating system. of the minicomputer 3 is processed by the processing unit 32 and the memory 33 after the minicomputer 3 is turned on.

As shown in FIG. 2, the components, for examples but not limited to, the resistors, the inductors, or the capacitors could be mounted on the mainboard 31. Moreover, the minicomputer 3 further includes a casing 30 covering the mainboard 31, the processing unit 32, the memory 33, the storage unit 34, the male connector 35, and the connector 36.

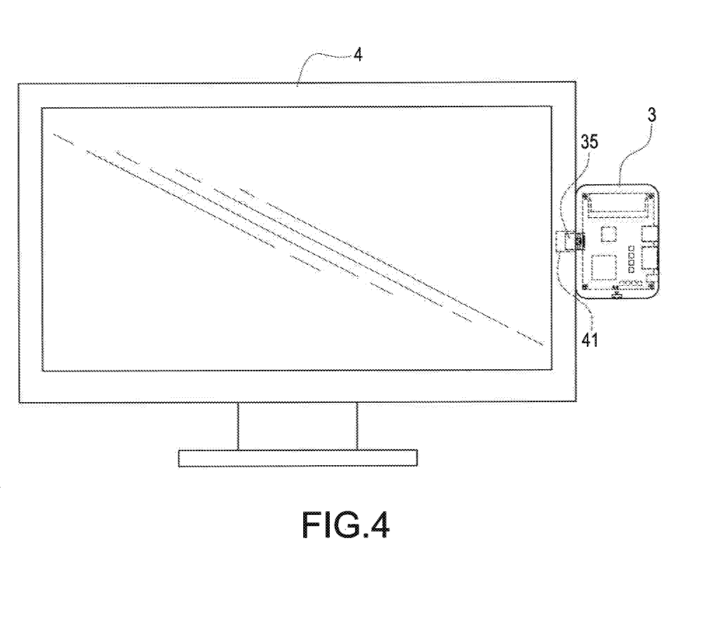

FIG. 4 shows a connection diagram of the minicomputer of the present invention. The video signals and audio signals generated by the operating system are outputted to an external monitor 4 for displaying. More specifically, the minicomputer 3 is plugged into a female connector 41 of the external monitor 4 through the male connector 35. Therefore, a cord connecting the minicomputer 3 and the external monitor 4 is not required. The video signals and audio signals of the minicomputer 3 are outputted through the male connector 35 and the female connector 41 to the external monitor 4 for displaying.

In this embodiment, the male connector 35 is, for example but not limited to, an HDMI male connector. The female connector 41 is, for example but not limited to, an HDMI female connector. The HDMI connector is able to transmit video signals and audio signals at the same time. However, the minicomputer 3 may have two different male connectors plugged into two different female connectors of the external monitor 4. Therefore, the video signals and the audio signals are transmitted separately through different connectors.

Moreover, the male connector 35 could be a male connector which is able to transmit power. The external monitor 4 includes a female connector in accordance with the male connector. Therefore, the minicomputer 3 receives electric power from the male connector 35. The minicomputer 3 does not require a power plug. In another word, the minicomputer 3 may have three different male connectors for transmitting/receiving video signals, audio signals, and electric power separately. Or, the minicomputer 3 has only one male connector for transmitting/receiving video signals, audio signals, and electric power. The present invention is not limited to above embodiment.

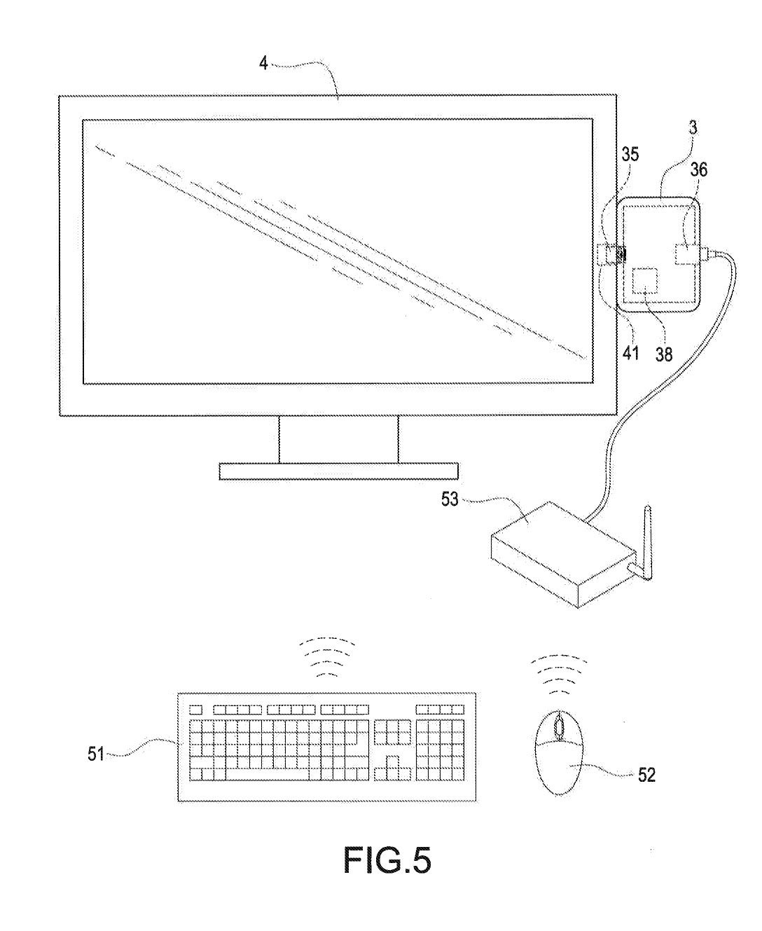

FIG. 5 shows a diagram showing how the minicomputer of the present invention is used. The minicomputer 3 does not include any display unit. Therefore, the minicomputer 3 is electrically connected to the external monitor 4 for displaying video and audio signals. Moreover, the minicomputer 3 does not include any input unit. The connector 36 is used for connecting to the peripherals, such as a keyboard 51 and a mouse 52. The user may input commands, and operate the operating system and related application programs through the keyboard 51 and the mouse 52. As shown in FIG. 5, the minicomputer 3 further includes a wireless transmission chip 38 electrically connected to the mainboard 31. Therefore, the minicomputer 3 is wirelessly connected to the keyboard 51 and the mouse 52 through the wireless transmission chip 38. More specifically, the wireless transmission chip 38 is, for example but not limited to, a Bluetooth (or Zigbee) transmission chip. The keyboard 51 and the mouse 52 are wireless apparatuses with Bluetooth (or Zigbee) transmission interfaces.

The connectors 36 include a network connector, such as an RJ-45 connector. Therefore, the minicomputer 3 is electrically connected to a modem 53 through a network cable 361. The minicomputer 3 is connected to the Internet through the modem 53.

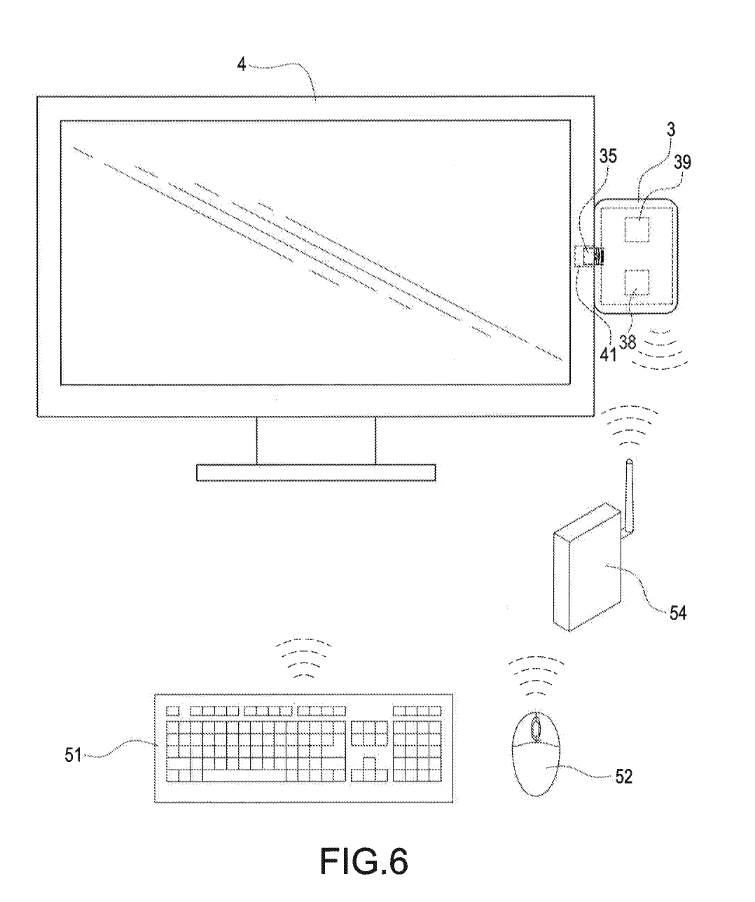

FIG. 6 shows another schematic diagram showing the application of the minicomputer of the present invention. In this embodiment, the minicomputer 3 further includes a wireless fidelity (Wi-Fi) module 39 electrically connected to the mainboard 31. Therefore, the minicomputer 3 is wirelessly connected to a wireless access point (wireless AP) 54 through the wireless fidelity module 39. In this embodiment, the minicomputer 3 is wirelessly connected to the keyboard 51 and the mouse 52 through the wireless (Bluetooth) transmission chip 38. The minicomputer 3 is wirelessly connected to the wireless access point 54 through the wireless fidelity module 39. Therefore, the minicomputer 3 does not require the connector 36. The minicomputer 3 is smaller and more portable. The user is much more willing to use the minicomputer 3.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A minicomputer electrically connected to an external monitor, the minicomputer including:
a mainboard;
a processing unit electrically connected to the mainboard;
a memory electrically connected to the mainboard;
a storage unit electrically connected to the mainboard, the storage unit storing an operating system of the minicomputer, the processing unit and the memory configured to process the operating system;
at least a connector electrically connected to the mainboard, the connector used to connect to peripherals of the minicomputer; and
at least a male connector electrically connected to the mainboard, the minicomputer plugged into a female connector of the external monitor through the male connector, the minicomputer configured to output video signals and audio signals generated by the operating system,
wherein the memory is a random access memory.

2. The minicomputer in claim 1, wherein the storage unit is a flash memory.

3. The minicomputer in claim 2, wherein the storage unit is a solid state disk.

4. The minicomputer in claim 1, wherein the male connector is a high definition multimedia interface male connector.

5. The minicomputer in claim 4, wherein the minicomputer receives electric power from the external monitor through the male connector; the minicomputer further includes a power switch electrically connected to the mainboard.

6. The minicomputer in claim 1, wherein the connector includes a universal serial bus connector.

7. The minicomputer in claim 1, wherein the connector includes an external serial advanced technology attachment connector.

8. The minicomputer in claim 1, wherein the connector includes an RJ-45 connector.

9. The minicomputer in claim 1, further including a wireless transmission chip electrically connected to the mainboard, the wireless transmission chip wirelessly connected to the peripherals of the minicomputer.

10. The minicomputer in claim 9, wherein the wireless transmission chip is a Bluetooth transmission chip.

11. The minicomputer in claim 1, further including a wireless fidelity module electrically connected to the mainboard, the minicomputer wirelessly connected to a wireless access point through the wireless fidelity module.
